(19) United States
(12) Patent Application Publication
(10) Pub. No.: US 2003/0173838 A1
(43) Pub. Date: Sep. 18, 2003

(54) Method and apparatus for removing vibration according to wobble of disc in disc drive

(75) Inventor: Young-Ok Koh, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/335,861

(22) Filed: Jan. 3, 2003

(30) Foreign Application Priority Data
Mar. 6, 2002 (KR) 2002-11868

(51) Int. Cl. H02K 5/24

(52) U.S. Cl. 310/51

(57) ABSTRACT

A method and an apparatus which removes vibration of a pickup. The apparatus adaptively controls a multi-speed of a disc drive to remove vertical vibration of the pickup, which occurs due to various wobble masses of a disc in the disc drive. The method includes detecting a mass of a wobble of a disc inserted into the disc drive using a focus driving signal generated in response to a driving of the disc drive, determining an allowable high multi-speed with respect to the disc according to the detected mass of the wobble of the disc, and driving the disc drive within a range that does not exceed the determined allowable high multi-speed. Accordingly, it is possible to prevent the vertical vibration of the disc in the disc drive regardless of the mass of the wobble of the disc.

### CROSS-REFERENCE TO RELATED APPLICATIONS

This application claims the benefit of Korean Patent Application No. 2002-11868 filed on Mar. 6, 2002, in the Korean Intellectual Property Office, the disclosure of which is incorporated herein by reference.

### BACKGROUND OF THE INVENTION

1. Field of the Invention

The present invention relates to an apparatus and a method of removing vibration in a disc drive, and more particularly, to an apparatus and a method of removing vertical vibration due to a wobble of a disc in a disc drive.

2. Description of the Related Art

Typically, vertical vibration in a disc drive occurs due to a wobble of a disc inserted into the disc drive. That is, a surface of the disc may become irregular and be wobbled due to a manufacturing process thereof and/or a distribution of the disc. For instance, during the distribution of discs, in a case where each disc is not stored in a hard case, its surface may be bent depending on the conditions of the environment where the disc is placed. This is due to liquefactive properties of a disc.

Driving a disc having a wobble causes a pickup to vibrate in upper and lower directions (hereinafter, referred to as vertical vibration) due to flux of air. The vertical vibration of the pickup prevents ordinary reading of data from the disc, and a user may feel the vibration of the disc drive where the vibration of the pickup intensifies.

To compensate for the vertical vibration of the pickup due to the wobble of the disc, a suggestion has been made to have a focus error compensation technique generate a stable focus OK signal FOK using an envelope signal of a radio frequency (RF) signal. However, this technique is not sufficient to reduce vertical vibration of a pickup that is generated according to various wobble of a disc.

### SUMMARY OF THE INVENTION

Accordingly, an object of the present invention is to provide an apparatus and a method of removing vibration, by which a speed of a disc drive can be adaptively controlled to remove vertical vibration of a pickup, according to various wobble masses of a disc in the disc drive.

Another object of the present invention is to provide an apparatus and a method of removing vibration, which removes vertical vibration of a pickup due to a wobble of a disc, using a focus driving signal FOD that is generated where the disc is driven.

Additional objects and advantages of the invention will be set forth in part in the description which follows and, in part, will be obvious from the description, or may be learned by practice of the invention.

To achieve the above and/or other objects of the present invention, there is provided a method of removing vibration due to a wobble of a disc in a disc drive, the method comprising detecting a mass of the wobble of the disc inserted into the disc drive using a focus driving signal generated in response to a driving of the disc drive, determining an allowable high multi-speed of the disc drive with respect to the disc according to the detected mass of the wobble of the disc, and driving the disc drive within a range that does not exceed the determined allowable high multi-speed.

The detecting of the mass of the wobble may include detecting the mass of the wobble using a peak-to-peak value of the focus driving signal detected for a predetermined section.

The detecting of the mass of the wobble may include converting the focus driving signal into a digital signal, and detecting a peak-to-peak value of the focus driving signal for a predetermined section with the digital signal that was converted from the focus driving signal and detecting the detected peak-to-peak value as the mass of the wobble.

The determining of the allowable high multi-speed may include comparing the detected mass of the wobble with a plurality of reference values and detecting a reference value thereof corresponding to the detected mass of the wobble, and setting a high multi-speed corresponding to the detected reference value as the allowable high multi-speed.

To achieve the above and/or other objects of the present invention, there is provided an apparatus which removes vibration due to a wobble of a disc in a disc drive, the apparatus comprising a pickup which reads information from the disc and transmits a radio-frequency signal, an amplifying unit which amplifies the radio-frequency signal transmitted from the pickup to a predetermined level and transmits a focus OK signal, a servo unit which outputs a focus driving signal in response to the focus OK signal transmitted from the amplifying unit, a detecting unit which detects a mass of the wobble of the disc with reference to a peak-to-peak value of the focus driving signal output from the servo unit for a predetermined section, and a system controller which determines an allowable high multi-speed corresponding to the disc based on the mass of the wobble detected by the detecting unit and controls a multi-speed of the disc drive within a range that does not exceed the determined allowable high multi-speed.

The detecting unit may include a converter which converts the focus driving signal output from the servo unit into a digital signal, and a detector unit which detects the peak-to-peak value based on the digital signal.

The system controller compares the peak-to-peak value detected by the detector unit with a plurality of reference values, detects a reference value thereof corresponding to the detected peak-to-peak value, and determines a high multi-speed corresponding to the detected reference value as the allowable high multi-speed.

To achieve the above and/or other objects of the present invention, there is also provided an apparatus which removes vibration due to a wobble of a disc in a disc drive, the apparatus comprising a pickup which reads information from the disc and transmits a radio-frequency signal, an amplifying unit which amplifies the radio-frequency signal transmitted from the pickup to a predetermined level and transmits a focus OK signal, a servo unit which outputs a focus driving signal in response to the focus OK signal transmitted from the amplifying unit, a first detecting unit which detects a mass of the wobble of the disc based on a peak-to-peak value of the focus driving signal output from the servo unit for a predetermined section, a second detecting unit which compares the mass of the wobble detected by the first detecting unit with a plurality of reference values and detects a reference value thereof corresponding to the detected mass of the wobble, and a system controller which determines an allowable high multi-speed with respect to the disc based on the reference value detected by the second detecting unit and controls a multi-speed of the disc drive in a range that does not exceed the determined allowable high multi-speed.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a block diagram of a disc drive having an apparatus for removing vibration according to an embodiment of the present invention; and

FIG. 2 is a flow chart explaining a method of removing vibration according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

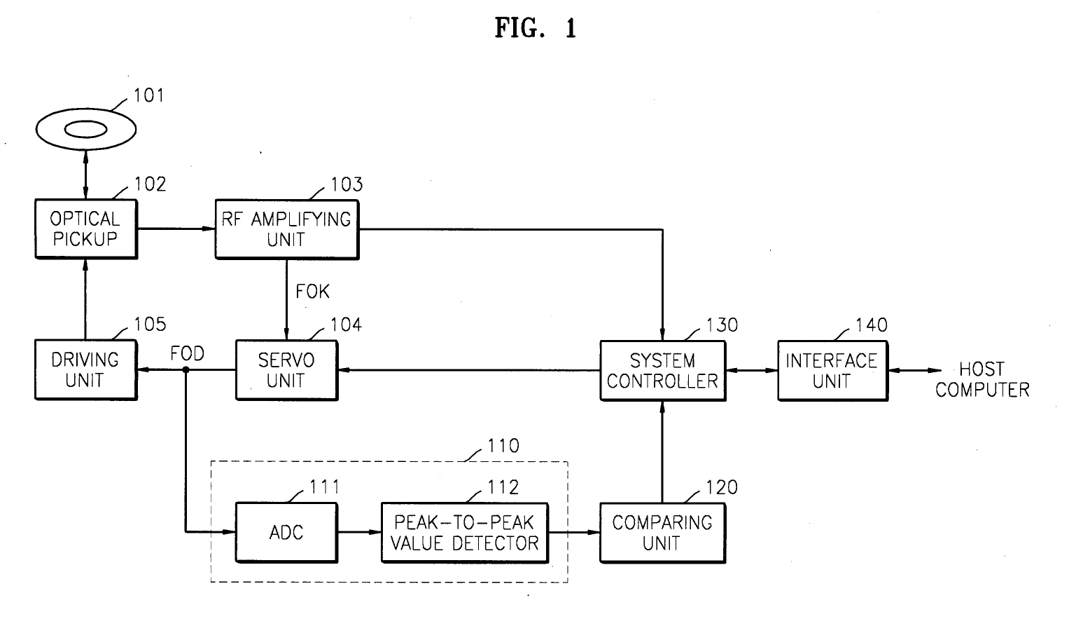

FIG. 1 shows a block diagram of a disc drive having an apparatus which removes vibration due to a wobble or a wobbling of a disc according to an embodiment of the present invention. Referring to FIG. 1, the disc drive includes an optical pick up 102 for a disc 101, a radio-frequency (RF) amplifying unit 103, a servo unit 104, a driving unit 105, a disc wobble mass detecting unit 110, a comparing unit 120, a system controller 130, and an interface unit 140. The disc wobble mass detecting unit 110 includes an analog-to-digital converter (ADC) 111 and a peak-to-peak value detector 112.

The disc 101 is, for example, an optical medium such as a compact disc (CD) or a digital versatile disc (DVD). The disc 101 may be a disc having no wobble or a disc having a wobble.

The optical pickup 102 emits light on the disc 101 where the disc 101 rotates, receives the light reflected from the disc 101, converts the received light into an analog RF signal, and outputs the analog RF signal.

The RF amplifying unit 103 amplifies the RF signal output from the optical pickup 102 to a predetermined level, and at the same time, generates a focus OK signal FOK from the RF signal. The FOK controls the focus of the optical pickup 102 with regard to the disc 101. Here, the FOK may be obtained from the analog RF signal using one of many methods known or to be developed.

The servo unit 104 outputs a focus driving signal FOD according to the FOK output from the RF amplifier 103 and a control signal output from the system controller 130. The focus driving signal FOD may also be obtained by the servo unit 104 using one of many methods known or to be developed.

The driving unit 105 controls an up-and-down movement of the optical pickup 102 in response to the focus driving signal FOD output from the servo unit 104 and helps the optical pickup 102 focus light on the disc 101.

The disc wobble mass detecting unit 110 detects a mass of a wobble (“wobble mass”) of the disc 101 inserted into the disc drive using the focus driving signal FOD output from the servo unit 104. In other words, the disc wobble mass detecting unit 110 detects a peak-to-peak value of the focus driving signal FOD for a predetermined section and detects the detected peak-to-peak value as the wobble mass of the disc 101. The predetermined section may be a section in which a one-period focus driving signal FOD is detected or the optical pickup 102 rotates the disc 101 by one rotation.

To detect the wobble mass of the disc 101, the ADC 111, which is included in the disc wobble mass detecting unit 110, converts the focus driving signal FOD output from the servo unit 104 into a digital signal. The peak-to-peak value detector 112 monitors the focus driving signal FOD transmitted from the ADC 111 in the predetermined section, detects the peak-to-peak value, and outputs the detected peak-to-peak value as the wobble mass of the disc 101.

The comparing unit 120 compares the wobble mass of the disc 101 output from the disc wobble mass detecting unit 110 with a plurality of reference values. The plurality of reference values are predetermined in consideration of an allowable high multi-speed of a disc drive. Where one of the reference values corresponding to the wobble mass is detected, the comparator 120 transmits the detected reference value to the system controller 130.

The system controller 130 sends a control signal, which is obtained from a focusing error signal FE output from the RF amplifying unit 103, to the servo unit 104. The servo unit 104 receives the control signal and outputs the control signal as a focus driving signal FOD. The system controller 130 also holds information regarding the multi-speed of the disc drive corresponding to the plurality of reference values set by the comparing unit 120. It is possible to store information regarding the multi-speed of the disc drive in an additional memory (not shown), which is not located in the system controller 130.

Where the system controller 130 holds the multi-speed information, it can detect the multi-speed corresponding to a reference value transmitted from the comparing unit 120 and set the detected multi-speed as an allowable high multi-speed with regard to the disc 101. At this time, the system controller 130 controls the multi-speed within a range that does not exceed the allowable high multi-speed.

In the event that the information regarding the multi-speed corresponding to the plurality of reference values is stored in the memory, the system controller 130 reads the multi-speed corresponding to the reference value transmitted from the comparing unit 120 among the plurality of multi-speeds stored in the memory. Next, the system controller 130 sets the read multi-speed information as an allowable high multi-speed with regard to the disc 101. Accordingly, the system controller 130 controls the multi-speed within a range that does not exceed the allowable high multi-speed.

The interface unit 140 allows data to be exchanged between the system controller 130 and a host computer (not shown).

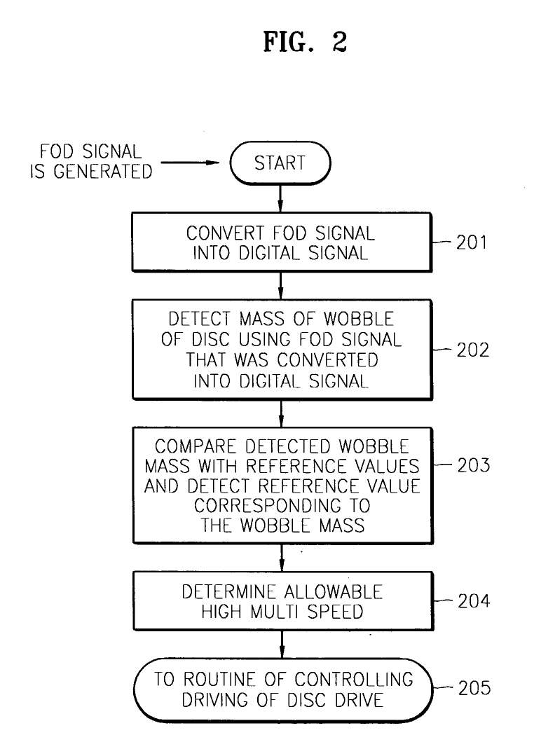

FIG. 2 shows a flow chart illustrating a method of removing vibration due to a wobble of a disc according to an embodiment of the present invention. Referring to FIG. 2, where the disc 101 is inserted into the disc drive shown in FIG. 1 and driven, and the focus driving signal FOD is generated by the servo unit 104, the disc drive converts the generated focus driving signal FOD into a digital signal in operation 201.

In operation 202, the disc drive detects the wobble mass of the disc 101, using the digital signal that was converted from the focus driving signal FOD. In other words, as described above, the peak-to-peak value detector 112 monitors the digital signal in a predetermined section to detect a peak-to-peak value of the focus driving signal FOD in the predetermined section. The predetermined section is defined with respect to the disc wobble mass detecting unit 110 of FIG. 1. The disc drive detects the detected peak-to-peak value as the wobble mass of the disc 101.

In operation 203, the wobble mass detected in the operation 202 is compared with the plurality of reference values, and one reference value corresponding to the wobble mass is detected. Here, the plurality of reference values are predetermined in consideration of allowable high multi-speeds of the disc drive.

In operation 204, the disc drive detects information regarding the multi-speed corresponding to the reference value detected in the operation 203 and sets it as the allowable high multi-speed of the disc 101 inserted into the disc drive. In operation 205, the disc drive proceeds to a routine of controlling a driving of the disc drive. The multi-speed of the disc drive is controlled within a range that does not exceed the allowable high multi-speed set in the operation 204.

According to the present invention, it is possible to prevent vertical vibration due to a wobbling of a disc, as the disc is driven in a disc drive regardless of a wobbling mass of the disc. In the present invention, an allowable high speed is determined according to a degree of a wobble of the disc detected using a focus driving signal, and a multi-speed of the disc drive is controlled within a range that does not exceed the allowable high multi-speed.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of removing vibration due to a wobble of a disc in a disc drive, the method comprising:
detecting a mass of the wobble of the disc inserted into the disc drive using a focus driving signal generated in response to driving of the disc drive;
determining an allowable high multi-speed of the disc drive with respect to the disc according to the detected mass of the wobble of the disc; and
driving the disc drive within a range that does not exceed the determined allowable high multi-speed.

2. The method of claim 1, wherein the detecting of the mass of the wobble comprises detecting the mass of the wobble using a peak-to-peak value of the focus driving signal detected for a predetermined section.

3. The method of claim 1, wherein the detecting of the mass of the wobble:
converting the focus driving signal into a digital signal; and
detecting a peak-to-peak value of the focus driving signal for a predetermined section with the digital signal that was converted from the focus driving signal and detecting the detected peak-to-peak value as the mass of the wobble.

4. The method of claim 1, wherein the determining of the allowable high multi-speed comprises:
comparing the detected mass of the wobble with a plurality of reference values and detecting a reference value thereof corresponding to the detected mass of the wobble; and
setting a high multi-speed corresponding to the detected reference value as the allowable high multi-speed.

5. An apparatus which removes vibration due to a wobble of a disc in a disc drive, the apparatus comprising:
a pickup which reads information from the disc and transmits a radio-frequency signal;
an amplifying unit which amplifies the radio-frequency signal transmitted from the pickup to a predetermined level and transmits a focus OK signal;
a servo unit which outputs a focus driving signal in response to the focus OK signal transmitted from the amplifying unit;
a detecting unit which detects a mass of the wobble of the disc with reference to a peak-to-peak value of the focus driving signal output from the servo unit for a predetermined section; and
a system controller which determines an allowable high multi-speed corresponding to the disc based on the mass of the wobble detected by the detecting unit and controls a multi-speed of the disc drive within a range that does not exceed the determined allowable high multi-speed.

6. The apparatus of claim 5, wherein the detecting unit comprises:
a converter which converts the focus driving signal output from the servo unit into a digital signal; and
a detector unit which detects the peak-to-peak value based on the digital signal.

7. The apparatus of claim 6, wherein the system controller compares the peak-to-peak value detected by the detector unit with a plurality of reference values, detects a reference value thereof corresponding to the detected peak-to-peak value, and determines a high multi-speed corresponding to the detected reference value as the allowable high multi-speed.

8. An apparatus which removes vibration due to a wobble of a disc in a disc drive, the apparatus comprising:
a pickup which reads information from the disc and transmits a radio-frequency signal;
an amplifying unit which amplifies the radio-frequency signal transmitted from the pickup to a predetermined level and transmits a focus OK signal;
a servo unit which outputs a focus driving signal in response to the focus OK signal transmitted from the amplifying unit;
a first detecting unit which detects a mass of the wobble of the disc based on a peak-to-peak value of the focus driving signal output from the servo unit for a predetermined section;
a second detecting unit which compares the mass of the wobble detected by the first detecting unit with a plurality of reference values and detects a reference value thereof corresponding to the detected mass of the wobble; and
a system controller which determines an allowable high multi-speed with respect to the disc based on the reference value detected by the second detecting unit and controls a multi-speed of the disc drive in a range that does not exceed the determined allowable high multi-speed.

9. The apparatus of claim 5, wherein the predetermined section is a section in which one period of the focus driving signal is detected.

10. The apparatus of claim 5, wherein the predetermined section is a section in which the optical pickup rotates the disc by one rotation.

11. The apparatus of claim 7, wherein the system controller stores information regarding the multi-speed of the disc drive corresponding to the plurality of reference values.

12. The apparatus of claim 7, further comprising a memory which stores information regarding the multi-speed of the disc drive corresponding to the plurality of reference values.

13. An apparatus which controls a disc drive having a pickup that reads information from a disc received thereto, the apparatus comprising:
an amplifying unit which amplifies a radio-frequency signal generated by the pickup and transmits a focus OK signal thereof;
a servo unit which outputs a focus driving signal in response to the focus OK signal; and
a system controller which detects a mass of a wobble of the disc with reference to a peak-to-peak value of the focus driving signal and adoptively controls a speed of the disc drive according to the detected mass of the wobble, so as to prevent vibration of the pickup.

14. The apparatus of claim 13, wherein the system controller comprises:
a disc wobble mass detection unit which detects the mass of the wobble using the peak-to-peak value of the focus driving signal detected for a predetermined section; and
a comparing unit which compares the peak-to-peak value with a plurality of reference values and detects a reference value thereof corresponding to the detected peak-to-peak value, wherein the system controller determines an allowable multi-speed corresponding to the detected reference value and controls the speed of the disc drive within a range that does not exceed the allowable high multi-speed.

15. A disc drive which operates a disc, comprising:
a pickup which reads information from the disc and transmits a radio-frequency signal;
an amplifying unit which amplifies the radio-frequency signal to a predetermined level and transmits a focus OK signal;
a servo unit which outputs a focus driving signal in response to the focus OK signal transmitted from the amplifying unit;
a system controller which detects a mass of a wobble of the disc and controls the disc drive according to the mass of the wobble; and
a driving unit which drives the optical pickup according to the system controller.

16. The apparatus of claim 15, wherein the system controller determines an allowable high multi-speed corresponding to the disc based on the mass of the wobble and controls a multi-speed of the disc drive within a range that does not exceed the determined allowable high multi-speed

17. The apparatus of claim 15, wherein the system controller comprises:
a disc wobble mass detection unit which detects the mass of the wobble according to a peak-to-peak reference value of the focus driving signal for a predetermined section; and
a comparing unit which compares the peak-to-peak value with a plurality of reference values and detects a reference value thereof corresponding to the detected peak-to-peak value, wherein the system controller determines an allowable multi-speed corresponding to the detected reference value and controls the speed of the disc drive within a range that does not exceed the allowable high multi-speed.

18. The apparatus of claim 17, wherein the predetermined section is a section in which one period of the focus driving signal is detected, or a section in which the optical pickup rotates the disc by one rotation.

19. The apparatus of claim 17, wherein the plurality of reference values are stored in the system controller.

20. The apparatus of claim 15, further comprising:
an interface unit which allows communication between the system controller and the outside of the disc driver; and
a memory which stores the plurality of reference values.

21. An apparatus which controls a disc drive having a pickup that reads information from a disc received thereto, the apparatus comprising:
an amplifying unit which amplifies a radio-frequency signal generated by the pickup and transmits a focus OK signal thereof;
a servo unit which outputs a focus driving signal in response to the focus OK signal; and
a system controller which determines an allowable multi-speed of the disc drive according to a mass of a wobble of the disc inserted into the disc drive using the focus driving signal and controls a multi-speed of the disc drive within a range that does not exceed the allowable multi-speed.

22. The apparatus of claim 21, wherein the system controller compares the mass of the wobble with a plurality of predetermined reference values, detects a reference value thereof corresponding to the mass of the wobble, and sets a corresponding multi-speed of the detected reference value as the allowable multi-speed of the disc drive.

23. A method of controlling a disc drive which operates a disc, the method comprising:
determining an allowable multi-speed of the disc drive according to a degree of a wobble of the disc inserted into the disc drive using a focus driving signal of the disc drive; and
controlling a multi-speed of the disc drive within a range that does not exceed the allowable multi-speed.

24. A method of determining an allowable multi-speed of a disc drive which operates a disc, the method comprising:
comparing a mass of a wobble of the disc with a plurality of predetermined reference values and detecting a reference value thereof corresponding to the mass of the wobble; and
setting a multi-speed of the disc drive corresponding to the detected reference value as the allowable multi-speed of the disc drive.
